(19) United States
(12) Patent Application Publication
(10) Pub. No.: US 2026/0278297 A1
(43) Pub. Date: Sep. 17, 2026

(54) EMAIL/SMS-DRIVEN TASK AUTOMATION AI-BASED SYSTEM AND METHOD

(71) Applicant: TapLaw Inc., Los Angeles, CA (US)

(72) Inventor: Nima Rajamand, Los Angeles, CA (US)

(21) Appl. No.: 19/565,390

(22) Filed: Mar. 12, 2026

Related U.S. Application Data
(60) Provisional application No. 63/772,315, filed on Mar. 14, 2025.

(51) Int. Cl. G06F 40/40; G06F 40/114; G06F 40/166; G06F 40/205; G06F 40/289; G06F 40/30; G06V 30/10; G06V 30/40; H04L 51/04

(52) U.S. Cl. CPC G06F 40/40; G06F 40/114; G06F 40/166; G06F 40/205; G06F 40/289; G06F 40/30; G06V 30/10; H04L 51/04; G06V 30/40

(57) ABSTRACT

A system includes: a processor; and memory containing instructions that, when executed by the processor, cause the processor to: receive a message over email or short message service (SMS); invoke one or more large language models (LLMs) to: identify a unique identifier associated with a sender of the message; analyze the message to identify a task; retrieve data corresponding to the task from a data silo associated with the unique identifier; invoke one or more microservices to perform the task based on the retrieved data; and generate a response; and transmit the response to the sender over email or SMS.

### CROSS-REFERENCE TO RELATED APPLICATION

The present application claims priority to and the benefit of U.S. Provisional Application No. 63/772,315, filed on Mar. 14, 2025, entitled “AI-BASED EMAIL/SMS-DRIVEN TASK AUTOMATION SYSTEM AND METHOD: Oliver AI”, the entire disclosure of which is incorporated by reference herein.

### BACKGROUND

### 1. Field

Aspects of embodiments of the present disclosure relate to an email/sms-driven task automation artificial intelligence-based system and method.

### 2. Description of Related Art

Email and SMS (Short Message Service) represent fundamental communication channels in both professional and personal contexts. Email with its standardized protocols (SMTP, IMAP, POP) and support for rich content (attachments, formatted text), and SMS with its ubiquity and immediacy, often serve as primary conduits for information exchange and task initiation. As such, a unified, AI-powered framework that effectively bridges these two communication modalities may be desired.

The above information disclosed in this Background section is for enhancement of understanding of the background of the present disclosure, and therefore, it may contain information that does not constitute prior art.

### SUMMARY

Some systems address individual tasks-such as optical character recognition (OCR) of emailed documents, summarization of email threads, scheduling appointments based on SMS requests, or utilizing AI models task automation-in isolation, relying on separate applications or services. This kind of fragmented approach may create inefficiencies, and may necessitate users to switch between multiple platforms, hindering productivity. Moreover, some AI-based platforms may require custom training or the generation of complex embeddings (e.g., converting text into high-dimensional vectors), creating significant barriers to adoption and limiting seamless integration of new tasks with previously processed data from both email and SMS sources.

Embodiments of the present disclosure may be directed to systems and methods that may automatically perform tasks with minimal user intervention for requests over email and other text and file-based communications.

According to one or more embodiments of the present disclosure a system includes: a processor; and memory containing instructions that, when executed by the processor, cause the processor to: receive a message over email or short message service (SMS); invoke one or more large language models (LLMs) to: identify a unique identifier associated with a sender of the message; analyze the message to identify a task; retrieve data corresponding to the task from a data silo associated with the unique identifier; invoke one or more microservices to perform the task based on the retrieved data; and generate a response; and transmit the response to the sender over email or SMS.

In an embodiment, to identify the unique identifier, the one or more LLMs may be configured to: parse metadata of the message; identify an email address or a phone number from the metadata of the message; and determine the unique identifier associated with the email address or the phone number.

In an embodiment, to analyze the message, the one or more LLMs may be configured to parse headers and body text of the message to: identify an intent of the sender of the message; determine entities identified in the message; identify command keywords; determine attachment identifiers; determine references to prior data or documents; and generate an analyzed message with attachments.

In an embodiment, the instructions, when executed by the processor, may further cause the processor to: retrieve the analyzed message with attachments; identify a document from the attachments; split the document into pages; perform optical character recognition (OCR) for each page of the document to generate a corresponding page object; recombine page objects of the document; split recombined page objects into chunks; invoke one or more LLMs to generate a chunk level summary of each of the chunks; recombine the chunk level summaries; and invoke one or more LLMs to generate a full document summary based on the recombined chunk level summaries.

In an embodiment, to retrieve the data corresponding to the task, the one or more LLMs may be further configured to: identify an analyzed message associated with the unique identifier; retrieve a document summary from the data silo associated with the analyzed message; determine whether or not the document summary is relevant to the task; in response to determining that the document summary is relevant, retrieve a chunk level summary associated with the document summary from the data silo; determine whether or not the chunk level summary is relevant to the task; in response to determining that the chunk level summary is relevant, retrieve a page object associated with the chunk level summary from the data silo; determine whether or not the page object is relevant to the task; and in response to determining that the page object is relevant, transmit the page object to the one or more microservices for further processing according to the task.

In an embodiment, the one or more microservices may include at least one of a shell generating microservice, a bates stamping microservice, a meeting scheduling microservice, a legal research performing microservice, or a text translating microservice.

In an embodiment, to generate the response, the one or more LLMs may be configured to: identify an analyzed message with attachments; receive one or more processed page objects from the one or more microservices; and generate the response including at least one of references to specific pages for documents, chunk identifiers, message timestamps, or newly generated links, based on the analyzed message and the one or more processed page objects.

According to one or more embodiments of the present disclosure, non-transitory computer readable media contains instructions that, when executed by a process, cause the processor to: receive a message over email or short message service (SMS); invoke one or more large language models (LLMs) to: identify a unique identifier associated with a sender of the message; analyze the message to identify a task; retrieve data corresponding to the task from a data silo associated with the unique identifier; invoke one or more microservices to perform the task based on the retrieved data; and generate a response; and transmit the response to the sender over email or SMS.

In an embodiment, to identify the unique identifier, the instructions may further cause the processor to invoke the one or more LLMs to: parse metadata of the message; identify an email address or a phone number from the metadata of the message; and determine the unique identifier associated with the email address or the phone number.

In an embodiment, to analyze the message, the instructions may further cause the processor to invoke the one or more LLMs to parse headers and body text of the message to: identify an intent of the sender of the message; determine entities identified in the message; identify command keywords; determine attachment identifiers; determine references to prior data or documents; and generate an analyzed message with attachments.

In an embodiment, the instructions may further cause the processor to: retrieve the analyzed message with attachments; identify a document from the attachments; split the document into pages; perform optical character recognition (OCR) for each page of the document to generate a corresponding page object; recombine page objects of the document; split recombined page objects into chunks; invoke one or more LLMs to generate a chunk level summary of each of the chunks; recombine the chunk level summaries; and invoke one or more LLMs to generate a full document summary based on the recombined chunk level summaries.

In an embodiment, to retrieve the data corresponding to the task, the instruction may further cause the processor to invoke the one or more LLMs to: identify an analyzed message associated with the unique identifier; retrieve a document summary from the data silo associated with the analyzed message; determine whether or not the document summary is relevant to the task; in response to determining that the document summary is relevant, retrieve a chunk level summary associated with the document summary from the data silo; determine whether or not the chunk level summary is relevant to the task; in response to determining that the chunk level summary is relevant, retrieve a page object associated with the chunk level summary from the data silo; determine whether or not the page object is relevant to the task; and in response to determining that the page object is relevant, transmit the page object to the one or more microservices for further processing according to the task.

In an embodiment, the one or more microservices may include at least one of a shell generating microservice, a bates stamping microservice, a meeting scheduling microservice, a legal research performing microservice, or a text translating microservice.

In an embodiment, to generate the response, the instructions may further cause the processor to invoke the one or more LLMs to: identify an analyzed message with attachments; receive one or more processed page objects from the one or more microservices; and generate the response including at least one of references to specific pages for documents, chunk identifiers, message timestamps, or newly generated links, based on the analyzed message and the one or more processed page objects.

According to one or more embodiments of the present disclosure, a method includes: receiving, by a processor, a message over email or short message service (SMS); invoking, by the processor, one or more large language models (LLMs) to: identify a unique identifier associated with a sender of the message; analyze the message to identify a task; retrieve data corresponding to the task from a data silo associated with the unique identifier; invoke one or more microservices to perform the task based on the retrieved data; and generate a response; and transmitting, by the processor the response to the sender over email or SMS.

In an embodiment, the identifying of the unique identifier may include: parsing, by the one or more LLMs, metadata of the message; identifying, by the one or more LLMs, an email address or a phone number from the metadata of the message; and determining, by the one or more LLMs, the unique identifier associated with the email address or the phone number.

In an embodiment, the analyzing of the message may include parsing, by the one or more LLMs, headers and body text of the message to: identify an intent of the sender of the message; determine entities identified in the message; identify command keywords; determine attachment identifiers; determine references to prior data or documents; and generate an analyzed message with attachments.

In an embodiment, the method may further include: retrieving, by the processor, the analyzed message with attachments; identifying, by the processor, a document from the attachments; splitting, by the processor, the document into pages; performing, by the processor, optical character recognition (OCR) for each page of the document to generate a corresponding page object; recombining, by the processor, page objects of the document; splitting, by the processor, recombined page objects into chunks; invoking, by the processor, one or more LLMs to generate a chunk level summary of each of the chunks; recombining, by the processor, the chunk level summaries; and invoking, by the processor, one or more LLMs to generate a full document summary based on the recombined chunk level summaries.

In an embodiment, the retrieving of the data corresponding to the task may include: identifying, by the one or more LLMs, an analyzed message associated with the unique identifier; retrieving, by the one or more LLMs, a document summary from the data silo associated with the analyzed message; determining, by the one or more LLMs, whether or not the document summary is relevant to the task; in response to determining that the document summary is relevant, retrieving, by the one or more LLMs, a chunk level summary associated with the document summary from the data silo; determining, by the one or more LLMs, whether or not the chunk level summary is relevant to the task; in response to determining that the chunk level summary is relevant, retrieving, by the one or more LLMs, a page object associated with the chunk level summary from the data silo; determining, by the one or more LLMs, whether or not the page object is relevant to the task; and in response to determining that the page object is relevant, transmitting, by the one or more LLMs, the page object to the one or more microservices for further processing according to the task. The one or more microservices may include at least one of a shell generating microservice, a bates stamping microservice, a meeting scheduling microservice, a legal research performing microservice, or a text translating microservice.

In an embodiment, the generating of the response may include: identifying, by the one or more LLMs, an analyzed message with attachments; receiving, by the one or more LLMs, one or more processed page objects from the one or more microservices; and generating, by the one or more LLMs, the response including at least one of references to specific pages for documents, chunk identifiers, message timestamps, or newly generated links, based on the analyzed message and the one or more processed page objects.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a block diagram of an AI-based email/sms-driven task automation system according to some embodiments of the present disclosure;

FIG. 2 is a block diagram of an example of the AI assistant of FIG. 1, according to some embodiments;

FIGS. 3A and 3B are flow diagrams illustrating a method for email/SMS driven task automation using an AI-based system;

FIGS. 4A and 4B are flow diagrams illustrating a method for processing email attachments according to one or more embodiments of the present disclosure;

FIGS. 5A and 5B are flow diagrams illustrating a flow of the data retriever in more detail according to one or more embodiments of the present disclosure;

FIGS. 6A and 6B illustrates an LLM implemented by an artificial neural network; and

FIGS. 7 to 11 illustrate some example email flows according to one or more embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one or more embodiments of the present disclosure, a unified, email and SMS-based, multi-modal AI assistant may be provided. The AI assistant may provide comprehensive functionality without requiring additional model training or embedding generation on the part of the user. By operating directly within the email and SMS environments, the AI assistant streamlines complex tasks and mitigates the need for specialized external tools, promoting efficiency and ease of use.

The systems and methods described herein improve computer-related technologies by performing certain processes and methods that cannot be done by conventional large language models (LLMs). For example, the systems and methods described herein provide a technical solution to a problem that is necessarily rooted in internet-centric technologies, that is, the ability to communicate via email/SMS to perform tasks and provide meaningful outputs in the form of generated document shells, completed legal forms, contextually rich responses with precise document and page-level citations, and actionable links to source materials. A single LLM, operating alone, cannot receive an email, parse its MIME-level structure, extract and OCR document attachments on any size and type, determine project relevance against a structured database of prior communications, retrieve relevant information through a hierarchical multi-level filtering process (at the document, chunk, and page levels), invoke specialized external microservices to generate new documents or perform domain-specific tasks, and compose a comprehensive response delivered back through the originating communication channel, without user intervention beyond the initial email or SMS request.

The systems and methods described herein orchestrate multiple pre-trained AI models, including general-purpose text LLMs, OCR engines, audio transcription models, and video understanding models, through a structured pipeline that removes document and data size limitations with well-defined inputs and outputs at each stage, enabling end-to-end task automation that no single model can achieve independently. In some embodiments, the systems and methods described herein may provide real-time or near-real-time processing of incoming email and SMS requests, automatically analyzing message content, retrieving relevant historical data across project-siloed databases, executing external tool functions, and delivering completed responses without any human intervention. In some embodiments, the systems and methods described herein may reduce the amount of processing workloads on resources (e.g., one or more processors) by employing a hierarchical data retrieval approach that progressively narrows the search space, first filtering by document category, then by document-level relevance, then by chunk-level relevance, and finally by page-level relevance, thereby avoiding the computational expense of processing entire document repositories for each user request.

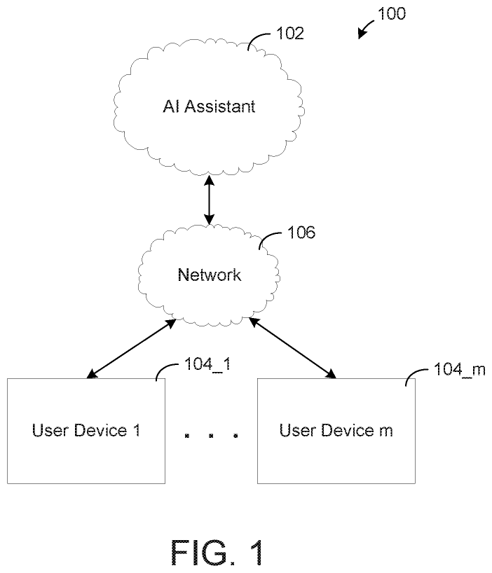

FIG. 1 is a block diagram of an AI-based email/sms-driven task automation system according to some embodiments of the present disclosure. The system 100 shown in FIG. 1 may be used, for example, as an artificial intelligence (AI) assistant 102 that performs various tasks based on requests in email/sms communications from a user device 104 (or, user devices 104_1 to 104_m, where m is a natural number greater than or equal to 1) over a network 106.

For example, in some embodiments, the network 106 may be structured to enable the exchange of data, values, instructions, messages, and/or the like among the AI assistant 102 and the user devices 104_1 to 104_m. In various embodiments, the network 106 may include any suitable wired or wireless network (e.g., a Local Area Network (LAN), a Wide Area Network (WAN), cellular communications network, and/or the like). For example, the network 106 may include Frequency Division Multiple Access (FDMA), Time Division Multiple Access (TDMA), Code Division Multiple Access (CDMA) (e.g., Evolution-Data Optimized (EVDO)), Universal Mobile Telecommunications Systems (UMTS) (e.g., Time Division Synchronous CDMA (TD-SCDMA or TDS)), Wideband Code Division Multiple Access (WCDMA), Long Term Evolution (LTE), evolved Multimedia Broadcast Multicast Services (eMBMS), High-Speed Downlink Packet Access (HSDPA), Universal Terrestrial Radio Access (UTRA), Global System for Mobile Communications (GSM), Code Division Multiple Access 1x Radio Transmission Technology (1x), General Packet Radio Service (GPRS), Personal Communications Service (PCS), 802.11X, ZigBee, Bluetooth, Wi-Fi, any suitable wired network, combinations thereof, and/or the like.

In some embodiments, the user devices 104_1 to 104_m may be personal computers, laptop computers, tablets, smartphones, and the like, each including a processing circuit having a processor and memory. In various embodiments, the processor may include a general-purpose processor, an Application Specific Integrated Circuit (ASIC), one or more Field Programmable Gate Arrays (FPGAs), a Digital Signal Processor (DSP), any other suitable electronic processing components, or combinations thereof. The memory may include tangible, non-transient, volatile memory or non-volatile memory, for example, such as Random Access Memory (RAM), Read-Only Memory (ROM), Non-volatile RAM (NVRAM), Flash Memory, hard disk storage, any other suitable electronic storage medium, or combinations thereof. The memory stores instructions (e.g., data, computer code, and/or programming logic) that, when executed by the processor, controls the operations of the user device 104. Accordingly, the memory includes database components, object code components, script components, and/or any other type of information structure for supporting the various activities and information structures described herein. In some embodiments, the user devices 104_1 to 104_m may have installed thereon, a general electronic messaging application, such as emails and/or SMS messaging applications, to allow the users of the user devices 104_1 to 104_m to communicate with the AI assistant 102 over the network 106. In some embodiments, the user devices 104_1 to 104_m may have installed thereon, a specific application or program (e.g., a web browser) that allows communications with the AI assistant 102 over the network 106.

The AI assistant 102 processes user requests (e.g., emails, SMS messages, and/or other suitable forms of electronic message communications) received from the user devices 104_1 to 104_m via the network 106, for example, through both standard email (using SMTP) and SMS messages (via SMS gateways). Upon receiving an incoming request, regardless of its origin (email or SMS) or size, the AI assistant 102 parses the message content of the request, identifies specific user instructions, extracts any relevant attachments (e.g., from emails), and detects references to previously processed data or tasks. As discussed in more detail below, the AI assistant 102 leverages a suite of pre-trained AI models (e.g., LLMs), encompassing optical character recognition (OCR), text summarization, named entity recognition (NER), intent classification, sentiment analysis, and other functionalities. This reliance on pre-trained models may eliminate the need for complex custom training or the creation of bespoke embedding pipelines, simplifying deployment and enhancing scalability.

In some embodiments, unlike systems relying solely on embeddings, the AI assistant's 102 retrieval layer may utilize hierarchical references and metadata. This structure facilitates the retrieval of context from previously processed emails, SMS messages, summaries, and documents. This allows the AI assistant 102 to generate hierarchical summaries: multi-layered representations of documents and communication threads. These summaries include page-level details (e.g., for documents), segment-level details (e.g., for SMS conversations, potentially grouping messages by date/time or topic), intermediate summaries (e.g., chunk-level for documents, thread-level for SMS, and the like), and top-level overviews without the limitations of traditional vector embedding based retrieval systems. This multi-faceted summarization approach generates both detailed and concise cross-links within the data, optimizing both information retrieval and overall comprehension with better retrieval than traditional vector embedding based retrieval. These tasks may be performed with the use of multiple Large Language Models (LLMs), which may be neural network based systems that are pre-trained for specific tasks, such as text based interactions, image processing, and other forms of intelligent data processing.

Furthermore, in some embodiments, the AI assistant 102 may integrate a robust structured function-calling system. This system, which uses formats like JSON schemas, enables the AI assistant system 102 to seamlessly execute external tools (e.g., microservices) and interact with external systems. This functionality allows the AI assistant 102 to handle various tasks, such as Bates-stamping a PDF document (e.g., received via email), generating a legal shell document (e.g., based on instructions in an email or SMS), scheduling appointments (e.g., triggered by an SMS request), or accessing external databases (e.g., prompted by an email query). This extensibility expands the AI assistant's 102 capabilities far beyond core AI processing.

In some embodiments, the AI assistant 102 composes a comprehensive and contextually appropriate output response, delivered either via email or SMS, depending on the user's initial communication channel and preferences. This response may include concise or detailed summaries, references to both newly processed and previously stored content (e.g., from either email or SMS archives), outputs generated by external tools, and direct links back to source documents or SMS message threads. This ensures a complete and informative response tailored to the user's request.

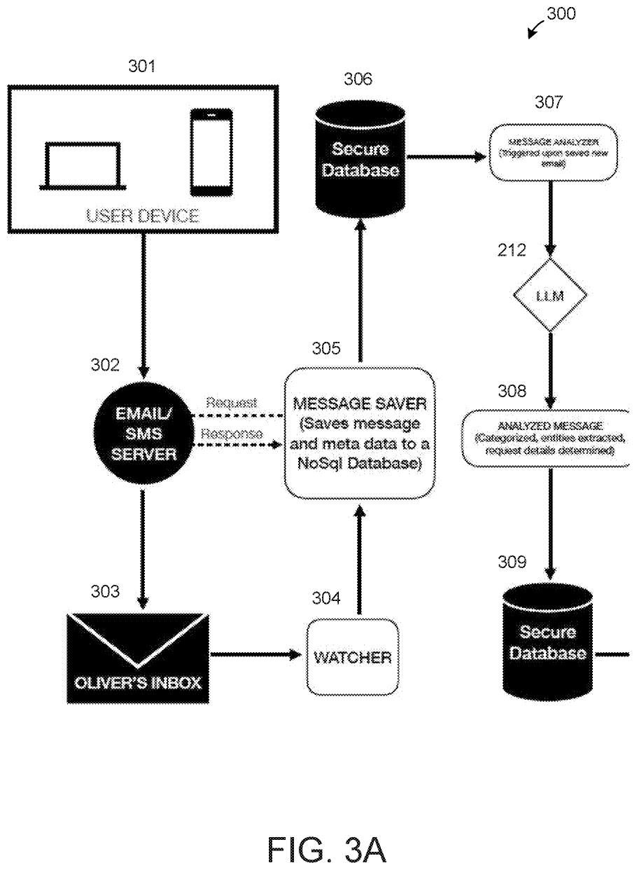

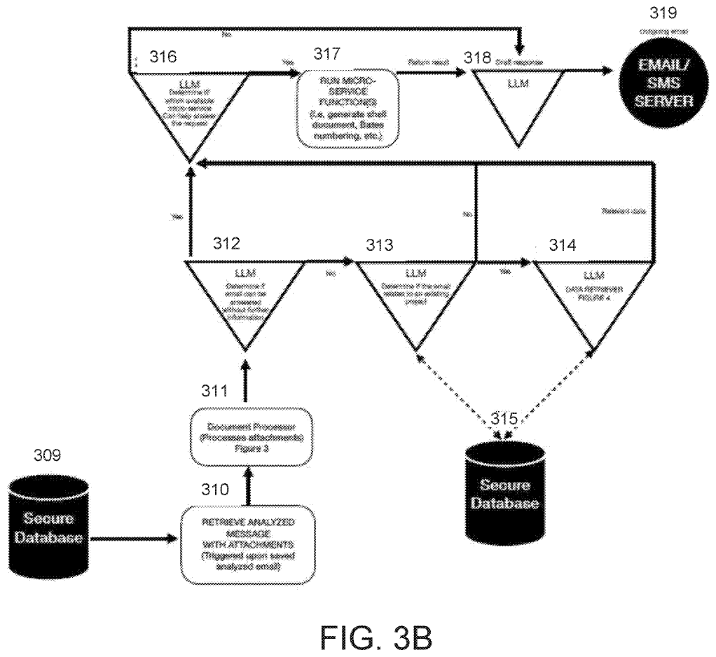

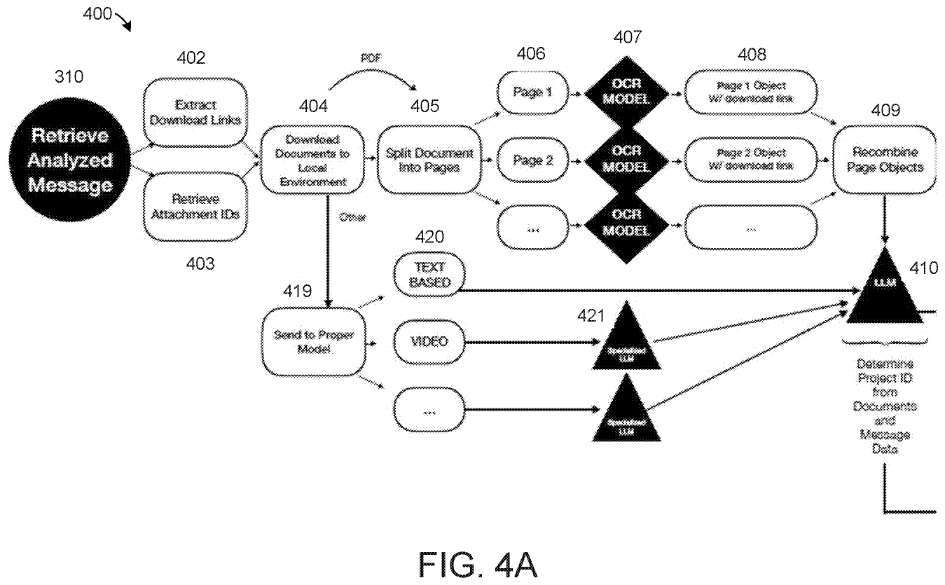

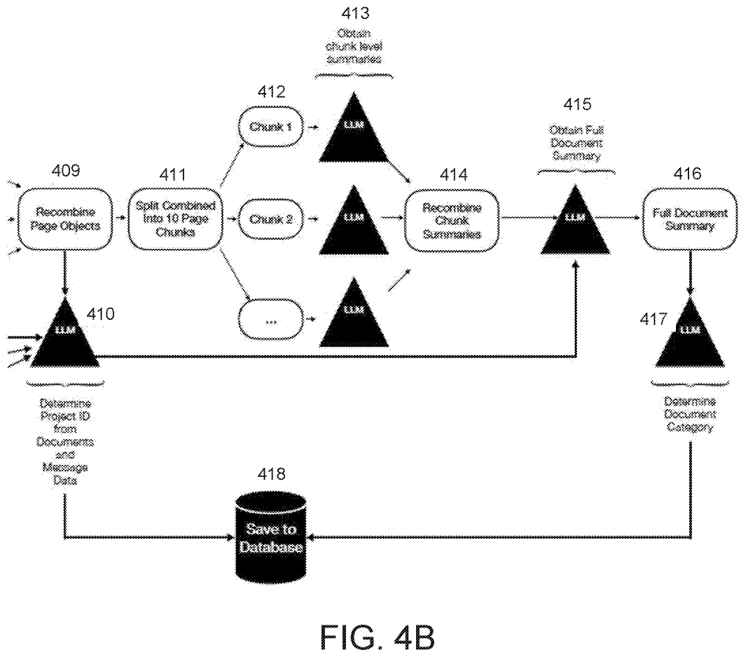

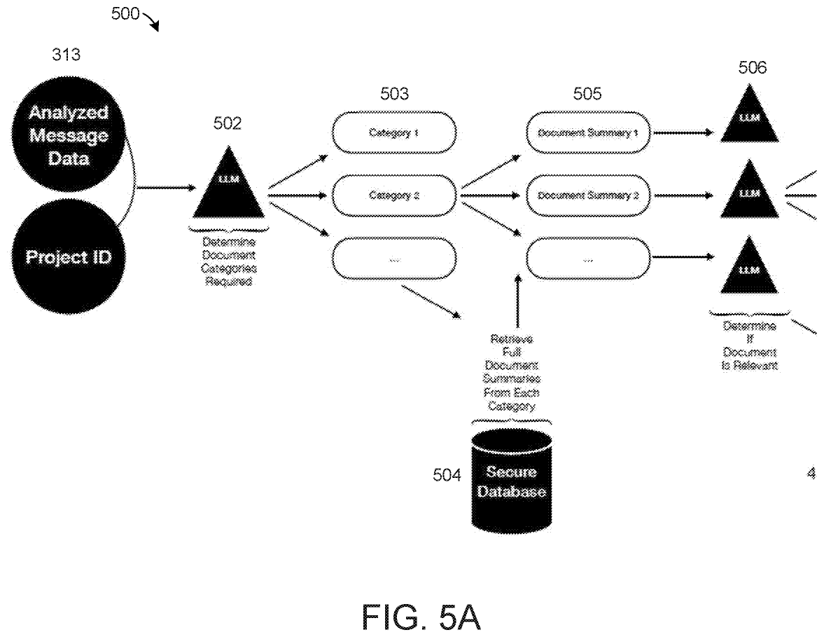

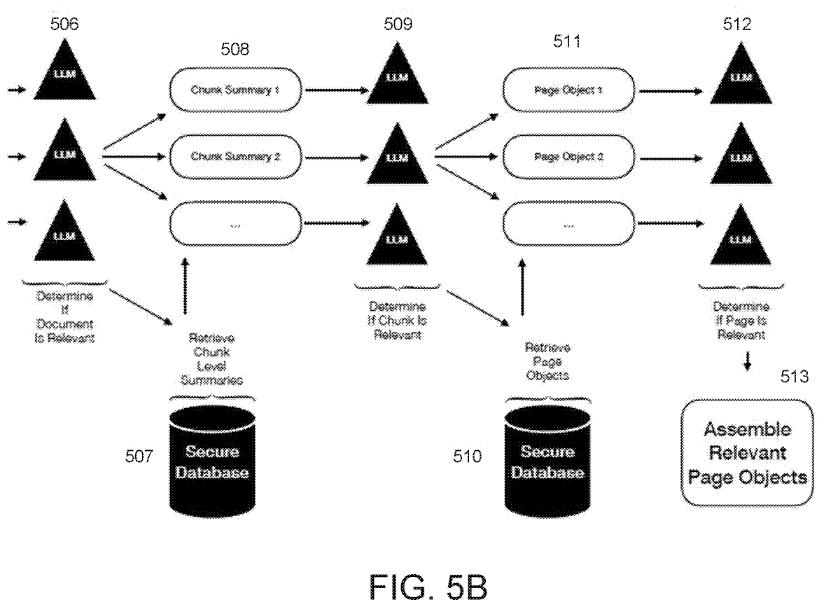

In some embodiments, the AI assistant 102 may create data silos to prevent co-mingling of user or project-level data without limiting the effectiveness of the retrieval system as would be seen in traditional vector embedding. This ensures confidentiality of data between various different users, clients, and projects while maintaining high accuracy on retrieval. The AI assistant creates and maintains data silos at the project level to prevent co-mingling of data between different users, clients, and matters. Each project is assigned a unique Project ID (determined at Nodes 313 and 410 of FIGS. 3B, 4A, and 4B). All documents, summaries, page objects, chunk summaries, and metadata associated with a project are stored in the secure database under that Project ID. When the Data Retriever (e.g., see FIG. 5) performs retrieval operations, it queries only within the scope of the matched Project ID, ensuring that data from one client's matter is never exposed in responses to another client's requests. Access controls are enforced at the sender level—the system validates that the requesting user (identified by email address or phone number) has authorized access to the project before retrieving any data. This data isolation is critical for legal and professional use cases where confidentiality and privilege must be maintained.

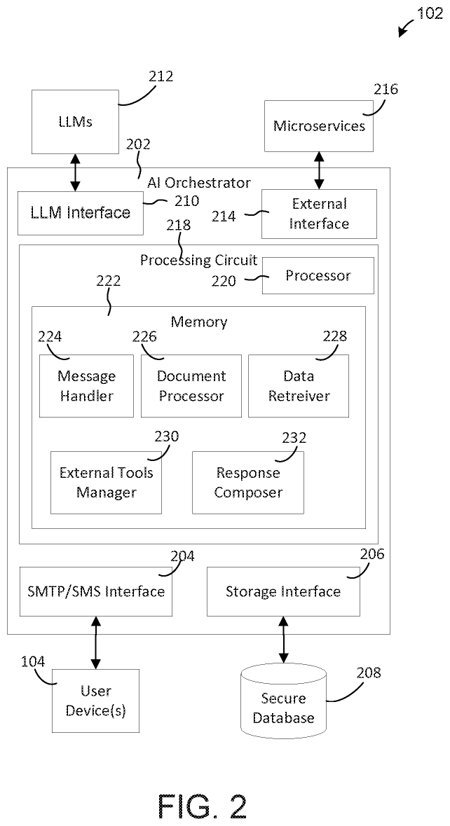

FIG. 2 is a block diagram of an example of the AI assistant 102 of FIG. 1, according to some embodiments.

Referring to FIG. 2, the AI assistant 102 includes an AI orchestrator 202 and various suitable interfaces, for example, such as an SMTP/SMS interface 204 for communications with a user device 104, a storage interface 206 for storing data in one or more secure databases 208, an LLM interface 210 for communicating with various pretrained Large Language Models (LLMs) 212, and an external interface 214 for communicating with various microservices 216 that perform various functions (e.g., external functions). While FIG. 2 shows each of the SMTP/SMS interface 204, the storage interface 206, the LLM interface 210, and the external interface 214 as separate interfaces, the present disclosure is not limited thereto, and in other embodiments, any two or more of the SMTP/SMS interface 204, the storage interface 206, the LLM interface 210, or the external interface 214 may be a part of the same interface.

In some embodiments, the interfaces 204, 206, 210, and 214 may be or include wired or wireless communications interfaces (e.g., jacks, antennas, transmitters, receivers, transceivers, wire terminals, and/or the like) for conducting data communications with the AI orchestrator 202. In various embodiments, communications via interfaces 204, 206, 210, and 214 can be direct (e.g., local wired or wireless communications) or via the communications network 106 (e.g., a WAN, the Internet, a cellular network, and/or the like). For example, interfaces 204, 206, 210, and 214 may include a Wi-Fi transceiver for communicating via a wireless communications network. In another example, interfaces 204, 206, 210, and 214 may include an Ethernet card and port for sending and receiving data via an Ethernet-based communications link or network. In another example, one or more of the interfaces 204, 206, 210, and 214 may include cellular or mobile phone communications transceivers. In various embodiments, the interfaces 204, 206, 210, and 214 may support various protocols (e.g., TCP/IP, User Datagram Protocol UDP, Hypertext Transfer Protocol HTTP, Internet Message Access Protocol IMAP, Simple Mail Transfer Protocol SMTP, and/or the like) and/or data communication interfaces (e.g., Application Program Interface API, Web Services, and/or the like) for facilitating data communications with the user device 104, the secured database 208, the LLMs 212, and the microservices 216.

In some embodiments, the AI orchestrator 202 includes a processing circuit 218 including a processor (e.g., one or more processors) 220 and memory (e.g., one or more memory devices) 222. The processing circuit 218 may be communicably connected to the SMTP/SMS interface 204, the storage interface 206, the LLM interface 210, and/or the external interface 214, such that the processing circuit 218 and the various components thereof can send and receive data via the interfaces 204, 206, 210, and 214.

The processor 220 may be implemented with a general-purpose processor, an ASIC, one or more FPGAs, a DSP, a group of processing components that are distributed over various geographic locations or housed in a single location or device, or other suitable electronic processing components. The memory (e.g., memory device, memory unit, one or more memory devices, storage device, or the like) 222 may be implemented with RAM, NVRAM, ROM, Flash Memory, hard disk storage, cloud storage, and/or other suitable electronic storage devices. The memory 222 stores data and/or computer code for facilitating at least some of the various processes described herein. The memory 222 includes tangible, non-transient, volatile or non-volatile memory. The memory 222 may include database components, object code components, script components, and/or any other type of information structure for supporting the various activities and information structures described in the present application.

According to an example embodiment, the memory 222 is communicably connected to processor 220 via processing circuit 218, and includes computer code for executing (e.g., by processing circuit 218 and/or processor 220) one or more processes described herein. For example, the memory 222 stores instructions or programming logic that, when executed by the processor 220, controls the operations of the AI orchestrator 202. In some embodiments, the processor 220 and the memory 222 may form or be part of various processing circuits in system 100 or the AI assistant 102.

Still referring to FIG. 2, in some embodiments, the memory 222 includes a message handler 224, a document processor 226, a data retriever 228, an external tools manager 230, and a response composer 232 (collectively referred to as services 224 to 232). Services 224 to 232 may receive inputs from the user device 104, the secure database 208, the LLMs 212, the microservices 216, and other data sources, determine actions for the AI orchestrator 202 based on the inputs, generate control signals based on the actions, and provide the generated control signals to the interfaces 204, 206, 210, and 214 for communicating with the user device 104, the secure database 208, the LLMs 212, and the microservices 216, respectively. For example, based on the control signals, the interfaces 204, 206, 210, and 214 may determine a page (e.g., a webpage), a query (e.g., a database query), a request (e.g., an API), a message (e.g., a response message), or the like to communicate with the user device 104, the secure database 208, the LLMs 212, and/or the microservices 216. A brief overview of some of the functions performed by each of the services 224 to 232 will be described in the following paragraphs, followed by more detailed description with reference to FIGS. 3 through 5B.

In some embodiments, the message handler 224 may receive messages via the SMTP/SMS interface 204, which may represent a general mail server or Mail Transfer Agent (MTA) capable of receiving email via SMTP and/or an SMS gateway for handling incoming SMS messages. This dual capability ensures that the AI assistant 102 can interact with users 104 through their preferred communication channel. The SMTP/SMS interface 102 acts as the unified entry point for all user interactions. Incoming messages, whether email or SMS, are forwarded to the message handler 224 for further processing.

The message handler 224 may include a message reader that is responsible for the initial parsing of all incoming messages. The message reader may intelligently handle both email (e.g., parsing at the MIME level to extract headers, body text, and attachments) and SMS messages (e.g., parsing the text content and identifying relevant metadata, such as sender phone number and timestamp). The message reader may extract user-submitted instructions, identify attachments and download links, isolate command keywords, and detect any references to previously processed data, regardless of whether that data originated from email or SMS communications. The analysis of the message may be performed with the use of one or many LLMs 212.

The document processor 226 may orchestrate the processing workflow with the use of several calls to an LLM 212, as described in more detail below with reference to FIGS. 4A and 4B. The document processor 226 may obtain user level data to determine project relevance based on sender metadata. The document processor 226 may process document attachments and download links. The document processor 226 may then trigger the data retriever 228, which is described in more detail below with reference to FIGS. 5A and 5B.

The data retriever 228 may be implemented as a structured index of relevant project level data. This design enables rapid and domain-agnostic access to information, regardless of whether it originated from email or SMS with the use of one or many LLMs 212.

The external tools manager 230 may translate recognized user instructions (e.g., “GenerateShellDocument,” “SummarizeEmailThread,” “ScheduleMeeting,” “TranslateSMSText”), and may combine the instructions with retrieved data into specific function calls that execute specialized tasks. These calls may be formatted according to predefined schemas (e.g., using JSON), and may be directed to the microservices (or external tools) 216. The microservices 216 may represent a collection of microservices that provide extended functionality beyond the AI assistant's 102 capabilities. Such services may include services for Bates stamping PDF documents where the document download link is provided along with user provided data to place a sequential stamp on each page of a specific document. Other services may include, but are not limited to, assembling new documents from templates, performing legal research, translating text between languages, scheduling appointments, or interacting with external APIs and databases. These microservices 216 process their assigned tasks and return outputs or updated links (e.g., links to newly generated documents or calendar entries) back to the AI orchestrator 202. While the microservices 216 are described in the contest of external tools, the present disclosure is not limited thereto, and in other embodiments, one or more of the microservices 216 may be included as a service or module in the AI orchestrator 202.

The microservices represent a modular, extensible collection of specialized task-execution services. Each microservice exposes a well-defined API with a JSON schema that specifies its required and optional parameters. The External Tools Manager (e.g., 230/Node 316) selects and invokes the appropriate microservice based on the LLM's function-call output. Current microservices include, but are not limited to: (a) GenerateShellDocument—creates legal document shells (e.g., interrogatory responses, discovery requests) from templates, populated with case-specific data retrieved from the project; (b) BatesStampPDF—applies sequential Bates numbering to each page of a PDF document; (c) ScheduleMeeting—interfaces with calendar APIs to schedule meetings; (d) PerformLegalResearch—queries legal research databases; (e) TranslateText—translates content between languages. Each microservice operates independently and returns its results (e.g., a download link to a generated document, a confirmation of a scheduled event) back to the AI Orchestrator for inclusion in the final response. In some embodiments, one or more of these microservices may be implemented as internal modules within the AI Orchestrator rather than as external services.

The response composer 232 may be the final stage in the processing pipeline. The response composer 232 may assemble a response to the user, intelligently merging hierarchical summaries generated by the other services or modules of the AI orchestrator 202, references to older data (from either email or SMS sources), and any results obtained from the external tools manager 230. The response composer 232 may then construct a properly formatted response, either as an email (e.g., using RFC 5322 compliance) or as an SMS message, depending on the original communication channel and user preferences with the use of one or more LLMs 212. The response composer 232 (e.g., via the message handler 224) may then generate and provide a response email/SMS (e.g., a final response email/SMS) to the user. The response communication may include clear references to specific pages (for documents), chunk IDs, message timestamps (for SMS), or newly generated links, providing the user with a comprehensive, contextually rich, and actionable response.

FIGS. 3A and 3B are flow diagrams illustrating a method for email/SMS driven task automation using an AI-based system (e.g., the AI assistant 102).

First, referring to FIG. 3A, the method 300 may be initiated with node 301, representing the user device 104, which may be a computer, a smartphone, or any other suitable device capable of sending and receiving email or SMS messages. Node 302 represents the SMTP/SMS interface (or an email/SMS server) 204, which acts as the initial receiving point for all communications. The SMTP/SMS interface 204 may handle both email (via SMTP) and SMS (via an SMS gateway) traffic.

Node 303 is the inbox where all messages, both email and SMS, are initially directed and stored. Node 304 represents a watcher of the message handler 224 that actively monitors the inbox 303, and detects newly arrived messages.

Upon detection of a new message (either email or SMS), at node 305, a message saver of the message handler 224 may save the message and its metadata to a secure database 306 (e.g., the secure database 208 of FIG. 2), which may be implemented as NoSql, but any suitable kind of database may be used. Once the message is saved, a message analyzer of the message handler 224 may be triggered at node 307. The message analyzer may perform the initial parsing and analysis of the incoming message. For emails, this may include robust MIME parsing to extract headers, body text, and attachments. For SMS messages, this may include parsing the text content and identifying relevant metadata (e.g., sender phone number). A large language model (LLM) 212 may assist in the analysis, and may determine the appropriate next steps. The core function of the message analyzer may be to extract user instructions, identify key entities and concepts, and determine the user's intent. The analyzed message, by the message analyzer, is represented in node 308, which is then saved to a secure database 309 (e.g., the secure database 208 of FIG. 2).

In Table 1 below, some example inputs and outputs for Node 307 of the LLM interaction are shown.

TABLE 1
(Node 307):

| | |
|---|---|
| Model Type | General-Purpose Text LLM (e.g., GPT-4 class or equivalent large |
| | instruction-tuned model) |
| Inputs | Raw email/SMS content including: (1) message headers (From, To, |
| | Subject, Date, CC/BCC); (2) full body text (plain text and/or HTML); (3) |
| | list of attachment filenames, MIME types, and sizes; (4) sender metadata |
| | (email address or phone number); (5) any quoted/forwarded thread |
| | content. |
| Outputs | A structured Analyzed Message object (e.g., JSON) containing: (1) |
| | user intent - classified intent category (e.g., “retrieve_information”, |
| | “generate_document”, “schedule_meeting”, “summarize”); (2) entities - |
| | extracted named entities (person names, case names, dates, project |
| | references); (3) command_keywords - explicit action keywords (e.g., |
| | “Bates stamp”, “shell response”, “summarize”); (4) |
| | attachment_references - list of attachment IDs for downstream |
| | processing; (5) prior_data_references - any references to previously |
| | processed projects or documents; (6) urgency_level - inferred priority of |
| | the request. |
| Notes | This LLM call performs the initial “understanding” of the user request. |
| | The prompt to the LLM includes a system instruction that defines the |
| | expected output schema. The LLM does NOT perform the actual task; it |
| | only classifies and extracts structured data from the raw message. |

Subsequently, referring to FIG. 3B, at node 310, when the analyzed message is saved, the message analyzer may send any attachments or links to other information to the document Processor 226 at node 311, which will be described in more detail below with reference to FIGS. 4A and 4B. Once the documents are processed, the entire message with the document data is sent to an LLM 212, at node 312, to make further determinations based on the users intent. If the message needs context of previous projects, it is handled via an LLM 212 to determine relevance at node 313, which determines if the message relates to an existing project, and then invokes the data retriever 228 at node 314, which is described in more detail below with reference to FIGS. 5A and 5B. The resulting aggregated data is then sent to an LLM 212 at node 316 to determine if the user's request requires the use of specialized external functionality, in which case a microservice 316 is triggered at node 317.

In Tables 2-4 below, example inputs and outputs for Nodes 312, 313, and 316 of the LLM interaction are shown.

TABLE 2
(Node 312):

| | |
|---|---|
| Model Type | General-Purpose Text LLM (same model as Node 307, different |
| | prompt/system instruction) |
| Inputs | (1) The structured Analyzed Message object from Node 308; (2) |
| | processed document data from the Document Processor (Node 311) |
| | including OCR text, document summaries, and metadata; (3) the user's |
| | original request text. |
| Outputs | A structured determination (e.g., JSON) containing: (1) |
| | can_answer_directly - boolean (Yes/No); (2) reasoning - brief |
| | explanation of why or why not; (3) missing_information - if No, what |
| | additional context is needed (e.g., “requires historical project data”, |
| | “needs prior correspondence context”). |
| Notes | This LLM call evaluates whether the system has enough information |
| | from the current message and its attachments alone to fulfill the user's |
| | request, or whether it needs to retrieve data from previously processed |
| | projects. If Yes, the flow proceeds directly to response composition. If |
| | No, the flow continues to Node 313. |

TABLE 3
(Node 313):

| | |
|---|---|
| Model Type | General-Purpose Text LLM (same base model, with a project-matching |
| | prompt) |
| Inputs | (1) The structured Analyzed Message object; (2) a list of existing project |
| | records associated with the sender (retrieved from the secure database), |
| | each containing: project_id, project_name, client_names, case_name, |
| | matter_type, date_range, and keywords; (3) content of any processed |
| | attachments. |
| Outputs | A structured determination (e.g., JSON) containing: (1) |
| | relates_to_existing_project - boolean; (2) matched_project_id - the ID |
| | of the matched project (if applicable); (3) confidence_score - a |
| | relevance confidence value; (4) matching_rationale - explanation of |
| | why this project was selected (e.g., matching case name, matching |
| | parties, matching document references). |
| Notes | The LLM compares the content and context of the incoming message |
| | against the metadata of each project in the sender's project list. This is not |
| | a simple keyword match - the LLM uses semantic understanding to |
| | determine relevance. For example, if a user writes about “Mata v Sigler” |
| | and a project exists with that case name, the LLM identifies the match |
| | even if phrased differently. |

TABLE 4
(Node 316):

| | |
|---|---|
| Model Type | General-Purpose Text LLM (with a function-calling/tool-use prompt) |
| Inputs | (1) The structured Analyzed Message object with classified intent; (2) |
| | aggregated data from the Data Retriever (Node 314) including relevant |
| | page objects and summaries; (3) a registry of available microservices |
| | with their descriptions, required parameters, and JSON schemas (e.g., |
| | GenerateShellDocument, BatesStampPDF, ScheduleMeeting, |
| | PerformLegalResearch). |
| Outputs | A structured function call (JSON) containing: (1) requires_microservice - |
| | boolean; (2) selected microservice - the name/ID of the |
| | microservice to invoke; (3) parameters - a populated JSON object |
| | conforming to the selected microservice's schema (e.g., for |
| | GenerateShellDocument: {template_type: “interrogatory_response”, |
| | case_name: “Mata v. Sigler”, propounding_party: “ . . . ”, responding_party: |
| | “ . . . ”, set_number: “One”, court: “Superior Court of CA”}); (4) |
| | fallback_action - what to do if the microservice is unavailable. |
| Notes | This is a structured function-calling LLM invocation. The LLM is |
| | provided with the available tools (microservices) and their schemas, and |
| | it selects the appropriate tool and populates its parameters based on the |
| | user's intent and the retrieved data. This is analogous to how modern |
| | LLM APIs support ‘function calling’ or ‘tool use’ capabilities. |

The results of the microservice 316 is returned to an LLM 212 at node 318 to compose a response email/SMS (e.g., a final email/SMS response). The response incorporates relevant information from the analyzed message, the retrieved data (e.g., the retrieved historical data), the outputs from the microservice(s) 216, and any generated summaries. The final composed response is then sent to the user at node 319 via the SMTP/SMS interface 204 according to the communication channels (e.g., email/SMS) of the original request from the user. The response, sent either via email or SMS, provides a complete and contextually rich answer to the user's original request, completing the workflow.

In Table 5 below, example inputs and outputs for Node 318 of the LLM interaction are shown.

TABLE 5
(Node 318):

| | |
|---|---|
| Model Type | General-Purpose Text LLM (with a response-formatting prompt) |
| Inputs | (1) The user's original request; (2) the structured Analyzed Message; (3) |
| | all retrieved relevant data (page objects, summaries, document references |
| | with download links); (4) microservice output results (e.g., a generated |
| | document link, Bates-stamped PDF link, scheduled meeting |
| | confirmation); (5) response formatting preferences (email vs. SMS, level |
| | of detail). |
| Outputs | A fully composed response message (natural language text) containing: |
| | (1) a greeting addressing the user by name; (2) direct answers to the |
| | user's questions with specific page/document citations; (3) inline |
| | references and download links to relevant documents; (4) any caveats or |
| | additional context; (5) a professional closing. For SMS responses, a |
| | condensed version with essential information only. |
| Notes | This is the final LLM call in the main pipeline. The LLM synthesizes all |
| | gathered information into a coherent, professional response. The prompt |
| | instructs the LLM to include specific document references (e.g., ‘found in |
| | Complaint.pdf, pg. 3’) and download links, to provide comprehensive yet |
| | concise answers, and to format appropriately for the communication |
| | channel (email = detailed, SMS = brief). |

FIGS. 4A and 4B are flow diagrams illustrating a method for processing email attachments according to one or more embodiments of the present disclosure. The method 400 illustrated in FIGS. 4A and 4B may be performed by the document processor 230 at node 311 described above with reference to FIGS. 3A and 3B.

First, referring to FIG. 4A, the method 400 may be initiated upon retrieving the analyzed message (e.g., node 310 in FIG. 3B). At node 402, any links in the message are extracted, and at node 403, attachment IDs are also retrieved, which allow downloading of any attachments. The documents are then downloaded to a local environment where the AI assistant 102 or the AI orchestrator 202 runs at node 404.

Once the documents are available in the local environment, if they are PDF documents, they are split into individual pages at node 405. This facilitates granular analysis and processing. Each page is then processed individually. For example, “Page 1” at node 406 may undergo “OCR Model” processing at node 407. This creates a “Page 1 Object w/download link” at node 408, containing the extracted text and a link to the original page image. This process may be repeated for “Page 2” and all subsequent pages (indicated by the ellipsis).

After processing all pages, a complete document may be reconstructed from its individual page representations at node 409.

On the other hand, if the document is not a PDF, a file type may be determined, and for each different file types, a different LLM 212 (e.g., a different LLM model) may be sent the file data at node 419, unless the document is a purely text based document at node 420, such as a .docx or .txt file, in which case, the text may be sent directly to node 410 described in more detail below.

At node 420, where the file is a video, or any other type of file, a suitable model (e.g. LLM 212) is selected, which is tailor-made and pre-trained for that file type. In the case of pure audio at node 420, an audio transcription model (e.g., LLM 212) is selected, and in the case of video, a video model (e.g., LLM 212) is selected at node 421.

Node 410 depicts using an LLM 212 to determine project ID from documents and email data. Based on the sender's metadata (e.g. phone number, email address, username, and/or the like), the document processor 226 queries a database for project IDs associated with the sender, and the list is sent to an LLM 212 at node 410 to determine whether or not the message and attachments relate to any of the projects in the list. All records are then related to an existing or a new project, and saved in the database at node 418, described in more detail below.

In Table 6 below, example inputs and outputs for Node 410 of the LLM interaction are shown.

TABLE 6
(Node 410):

| | |
|---|---|
| Model Type | General-Purpose Text LLM (with a project-classification prompt) |
| Inputs | (1) Sender metadata (email address, phone number, username); (2) |
| | extracted document content (OCR text for PDFs, raw text for text files, |
| | specialized model output for media files); (3) document metadata |
| | (filename, file type, creation date); (4) a list of existing projects |
| | associated with the sender from the database, each with: project_id, |
| | project_name, associated_parties, document_categories, date_range; (5) |
| | the original message content/subject line. |
| Outputs | A structured determination (JSON) containing: (1) project_id - either an |
| | existing project ID or a flag indicating a new project should be created; |
| | (2) confidence_score; (3) new_project_metadata (if new) - suggested |
| | project_name, client_name, matter_type derived from the document |
| | content; (4) classification_rationale - why the document was assigned to |
| | this project. |
| Notes | This LLM call determines which project a newly processed document |
| | belongs to. It analyzes both the document content and the sender's |
| | existing project portfolio to make an intelligent assignment. This is |
| | critical for maintaining proper data silos - documents must be associated |
| | with the correct project to prevent data co-mingling between different |
| | clients/matters. |

In the case of a PDF, the resulting recombined data at node 409 as well as the original document files are also passed to the LLM 212 at node 410 described above, and saved at the database at node 418. Referring to FIG. 4B, the recombined PDF document at node 409 is then split into manageable chunks (e.g., 10-page chunks) at node 411. The chunking may facilitate efficient summarization, and does not have to be 10 pages per chunk. “Chunk 1” is shown as an example at node 412. An LLM 212 creates chunk level summaries at node 413. The chunk level summaries are recombined at node 414. Node 415 shows an LLM 212 generating a full document summary from the recombined chunk level summaries, and at node 417, an LLM 212 is leveraged to determine document category.

Finally, all extracted data, including page objects, chunk summaries, the full document summary, category, OCR text (if applicable), and metadata, are saved to the database at node 418. This ensures that all processed information is securely stored and readily available for future retrieval.

In Tables 7-11 below, example inputs and outputs for Nodes 419/421, 407, 413, 415, and 417 of the LLM interactions are shown.

TABLE 7
(Node 419/421):

| | |
|---|---|
| Model Type | Specialized Pre-trained Models (different from the general-purpose text |
| | LLM): (a) Audio Transcription Model (e.g., Whisper-class speech-to- |
| | text); (b) Video Understanding Model (e.g., a multi-modal model capable |
| | of processing video frames and audio); (c) Image Analysis Model (for |
| | non-PDF image files) |
| Inputs | For audio: raw audio file data (WAV, MP3, etc.). For video: video file |
| | data (MP4, MOV, etc.) including both visual frames and audio track. For |
| | images: image file data (JPEG, PNG, etc.). |
| Outputs | For audio: full text transcription with timestamps. For video: text |
| | transcription of audio + descriptions of key visual content/scenes + any |
| | on-screen text (OCR). For images: extracted text (OCR) + image |
| | description/classification. |
| Notes | These are DIFFERENT models from the general-purpose text LLM used |
| | elsewhere in the system. Each is a specialized, pre-trained model |
| | optimized for its specific modality. The key point is that these models are |
| | pre-trained and do not require any custom training or fine-tuning by the |
| | user. The system selects the appropriate model based on file type |
| | detection at Node 419. |

TABLE 8
(Node 407):

| | |
|---|---|
| Model Type | Specialized OCR Engine (e.g., Tesseract, Google Vision OCR, or similar |
| | pre-trained OCR model - this is a dedicated OCR model, not a general- |
| | purpose LLM) |
| Inputs | A single page image (rasterized from the PDF split at Node 405). The |
| | image is the visual representation of one page of the PDF document. |
| Outputs | A Page Object containing: (1) extracted_text - the full OCR-recognized |
| | text content of the page; (2) download_link - a URL/reference to the |
| | stored original page image; (3) page_number; (4) confidence_score - |
| | OCR confidence metric; (5) bounding_boxes (optional) - coordinate |
| | data for each recognized text block. |
| Notes | The OCR model is applied independently to each page of a PDF. This |
| | per-page processing enables granular referencing later - the system can |
| | cite specific pages in its responses. The OCR model is separate from the |
| | LLMs and is a dedicated pre-trained model for optical character |
| | recognition. |

TABLE 9
(Node 413):

| | |
|---|---|
| Model Type | General-Purpose Text LLM (with a summarization prompt; may use a |
| | model optimized for long-context processing) |
| Inputs | A text chunk consisting of the combined OCR text (or raw text) from |
| | approximately 10 consecutive pages of a document, along with: (1) page |
| | numbers covered by this chunk; (2) document metadata (filename, total |
| | pages, document type). |
| Outputs | A Chunk Summary object containing: (1) summary_text - a concise |
| | summary (typically 200-500 words) capturing the key information, |
| | arguments, dates, names, and facts in the chunk; (2) key_entities - |
| | names, dates, amounts, and other significant data points extracted; (3) |
| | chunk_id; (4) page_range - the pages covered. |
| Notes | Each chunk is summarized independently. The chunk size (default ~10 |
| | pages) is configurable and balances between providing enough context |
| | for meaningful summarization and staying within the LLM's context |
| | window. A summarization-specific prompt instructs the LLM to preserve |
| | factual details, legal terms, dates, and party names. |

TABLE 10
(Node 415):

| | |
|---|---|
| Model Type | General-Purpose Text LLM (with a meta-summarization prompt) |
| Inputs | (1) All recombined chunk summaries from Node 414 (the complete set of |
| | chunk-level summaries for the entire document); (2) document metadata |
| | (filename, total pages, file type, sender information). |
| Outputs | A Full Document Summary containing: (1) executive_summary - a |
| | high-level overview of the entire document (typically 100-300 words); |
| | (2) document_type_description - what kind of document it is (e.g., |
| | “legal complaint”, “contract”, “correspondence”); (3) key_parties - all |
| | parties/entities mentioned; (4) key_dates - significant dates; (5) |
| | key_issues - main topics or legal issues addressed. |
| Notes | This is a ‘summary of summaries' - it synthesizes the chunk-level |
| | summaries into a single coherent overview. This hierarchical approach |
| | (page → chunk → full document) allows the system to process |
| | documents of any length without hitting LLM context window limits. |

TABLE 11
(Node 417):

| | |
|---|---|
| Model Type | General-Purpose Text LLM (with a classification prompt) |
| Inputs | (1) The Full Document Summary from Node 416; (2) a predefined |
| | taxonomy of document categories relevant to the domain (e.g., for legal: |
| | “Pleading”, “Discovery”, “Correspondence”, “Contract”, “Court Order”, |
| | “Motion”, “Evidence”, “Billing”, etc.); (3) document metadata. |
| Outputs | A structured classification (JSON) containing: (1) primary_category - |
| | the main category label; (2) secondary_categories - any additional |
| | applicable categories; (3) confidence_score; (4) classification_rationale. |
| Notes | Document categorization enables the Data Retriever (FIG. 5) to |
| | efficiently narrow its search scope. Instead of scanning all documents in a |
| | project, the system first identifies which categories of documents are |
| | relevant to the user's request, then only retrieves and evaluates |
| | documents within those categories. |

FIGS. 5A and 5B are flow diagrams illustrating a flow of the data retriever 228 in more detail according to one or more embodiments of the present disclosure. The method 500 illustrated in FIGS. 5A and 5B may be performed by the data retriever 228 at node 314 described above with reference to FIGS. 3A and 3B.

The method 500 starts with the analyzed message data, and if available, a project ID from the LLM 212 at node 313 in FIG. 3B. The data retriever 228 then uses an LLM 212 at node 502 to first determine document categories required to answer the sender's request. This determination is optional as the system would work with or without this category determination, however in some instances this category determination may allow for faster processing. Two sample categories are illustrated, “Category 1” and “Category 2” at node 503. Based on the categories, relevant data within the categories are retrieved from the secure database (e.g., the secure database 208) at node 504, from which document summaries are retrieved at node 505. For example, FIG. 5A illustrates “Document Summary 1” and “Document Summary 2.”

In Table 12 below, example inputs and outputs for Node 502 of the LLM interactions are shown.

TABLE 12
(Node 502):

| | |
|---|---|
| Model Type | General-Purpose Text LLM (with a search-planning prompt) |
| Inputs | (1) The Analyzed Message data (user's request, intent, entities); (2) the |
| | matched Project ID; (3) the list of available document categories within |
| | the matched project (retrieved from the database). |
| Outputs | A structured list (JSON) containing: (1) required_categories - an |
| | ordered list of document category labels that are likely to contain |
| | information needed to answer the user's request; (2) search_rationale - |
| | why each category was selected. |
| Notes | This LLM call acts as a ‘search planner.’ For example, if a user asks for |
| | ‘the case number and causes of action for Mata v. Sigler,’ the LLM |
| | would identify categories like ‘Pleading’ and ‘Court Order’ as most likely |
| | to contain that information. This intelligent pre-filtering significantly |
| | reduces the number of documents that need to be evaluated in subsequent |
| | steps. |

Each full document summary is sent to an LLM 212 to determine if the document is relevant to the sender's request at node 506. Referring to FIG. 5B, if a document is determined to be relevant, the data retriever 228 retrieves the chunk level summaries for each relevant document from the secure database (e.g., the secure database 208) at node 507. Then, at node 508, one or more of the chunk summaries are sent to an LLM 212 to determine if each chunk is relevant to the sender's request. If a chunk is determined to be relevant to the sender's request at node 509, the system retrieves each page object in the chunk from the database at node 510. For each page at node 511, the process repeats one final time to determine if the page data is relevant to the sender's request using one or more LLMs 212 at node 512. Finally, the data retriever 228 assembles the relevant page objects at node 513 and other relevant data for constructing the final response. One or more LLM's 212 are used to determine relevance throughout this process.

In Tables 13-15 below, example inputs and outputs for Nodes 506, 509, and 512 of the LLM interactions are shown.

TABLE 13
(Node 506):

| | |
|---|---|
| Model Type | General-Purpose Text LLM (with a relevance-evaluation prompt) |
| Inputs | (1) The user's original request text; (2) the Analyzed Message data |
| | (intent, entities); (3) a single Full Document Summary (from Node 505). |
| Outputs | A structured determination (JSON) containing: (1) is_relevant - |
| | boolean; (2) relevance_score - numerical confidence; (3) |
| | relevance_rationale - why this document is or is not relevant to the |
| | user's request. |
| Notes | This LLM call is invoked once per document summary within the |
| | selected categories. It is the first level of the hierarchical relevance |
| | filtering. Only documents determined to be relevant proceed to chunk- |
| | level evaluation. This is a critical efficiency mechanism - it prevents the |
| | system from performing expensive page-level analysis on irrelevant |
| | documents. |

TABLE 14
(Node 509):

| | |
|---|---|
| Model Type | General-Purpose Text LLM (same model as Node 506, with chunk-level |
| | relevance prompt) |
| Inputs | (1) The user's original request text; (2) a single Chunk Summary (from |
| | Node 508); (3) the parent document's metadata (document name, |
| | category, project). |
| Outputs | A structured determination (JSON) containing: (1) is_relevant - |
| | boolean; (2) relevance_score; (3) relevant_aspects - which specific parts |
| | of the user's request this chunk might address. |
| Notes | Second level of hierarchical relevance filtering. Applied only to chunks |
| | from documents that passed the document-level filter at Node 506. This |
| | narrows the search from potentially hundreds of pages to only the most |
| | relevant chunks. |

TABLE 15
(Node 512):

| | |
|---|---|
| Model Type | General-Purpose Text LLM (same model, with page-level relevance |
| | prompt) |
| Inputs | (1) The user's original request text; (2) a single Page Object (from Node |
| | 511) containing the full OCR text or raw text of one page; (3) the parent |
| | chunk and document metadata. |
| Outputs | A structured determination (JSON) containing: (1) is_relevant - |
| | boolean; (2) relevance_score; (3) extracted_answer_fragments - specific |
| | text passages from the page that are relevant to the user's request; (4) |
| | page_reference - page number and document name for citation. |
| Notes | Third and finest level of hierarchical relevance filtering. This is the most |
| | granular evaluation. The LLM examines actual page content (not |
| | summaries) to find specific information that answers the user's request. |
| | The extracted_answer_fragments are what ultimately appear in the |
| | system's response, along with precise page citations (e.g., ‘found in |
| | Complaint.pdf, pg. 3’). |

The final assembled data is then passed to node 316 as described above with reference to FIG. 3B.

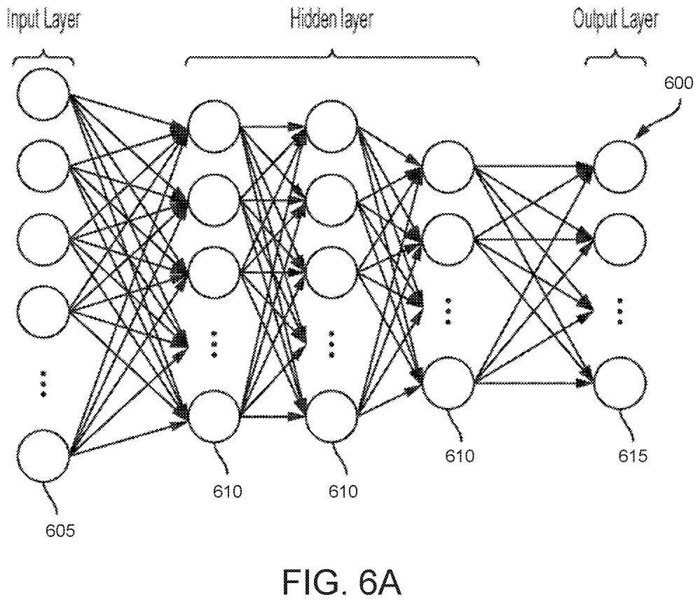

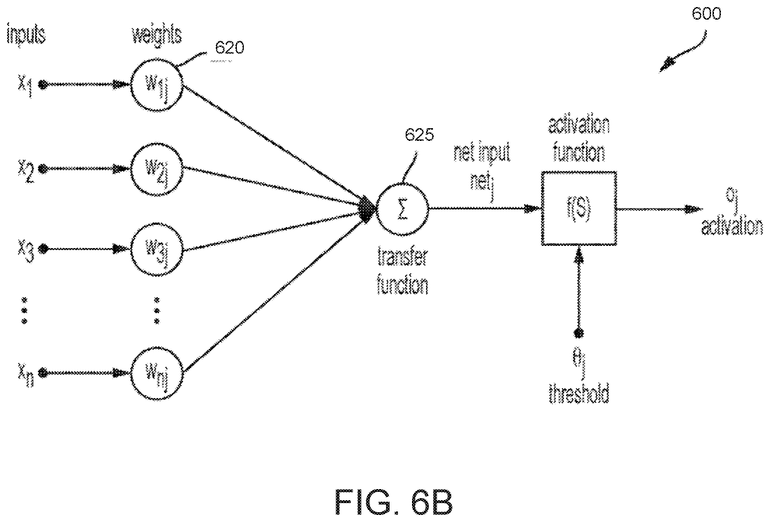

FIGS. 6A and 6B illustrates an LLM implemented by an artificial neural network. FIG. 6A is a diagram of an artificial neural network. FIG. 6B is a diagram of a neuron of an artificial neural network.

Referring to FIGS. 6A and 6B, the artificial neural network system includes a plurality of neural network nodes or neurons 600. The neural network nodes 600 form an input layer 605, one or more hidden layers 610, and an output layer 615. A plurality of connections may be formed between the neural network nodes 600, for example, as illustrated in FIG. 6A. A weighted sum (or “linear combination”) of the inputs is formed (e.g., each input is multiplied by a respective weight or parameter 620, and the sum 625 of these products is formed) as illustrated in FIG. 6B. The weighted sum is processed by an activation function f(S), which may be any suitable nonlinear function (e.g., DNN function), for example, such as a nonlinear thresholding function.

Modern LLMs, such as those used in the present system according to some embodiments, are based on the Transformer architecture, which uses self-attention mechanisms within the hidden layers to capture long-range dependencies in input sequences. These models contain billions of parameters trained on large text corpora. The general-purpose text LLMs used in the present system according to some embodiments are instruction-tuned variants, meaning they have been additionally fine-tuned (e.g., by their developers) to follow natural language instructions. The specialized models (OCR, audio transcription, video, and the like) use architectures optimized for their respective modalities but follow the same fundamental neural network principles shown in FIGS. 6A and 6B.

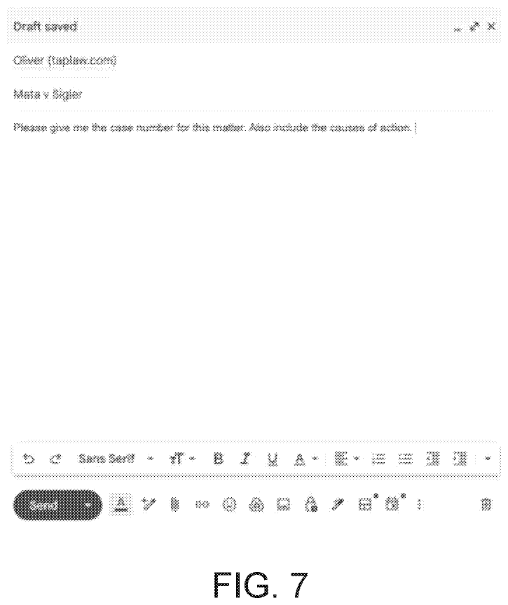

FIGS. 7 to 11 illustrate some example email flows according to one or more embodiments of the present disclosure.

Referring to FIGS. 7 to 11, some example scenarios are shown, illustrating how the AI assistant 102 processes various emails, and similarly, would apply to SMS requests as well. FIGS. 7 to 11 demonstrate the flow of information for tasks.

Referring to FIG. 7, a user requesting a case number and causes of action via email is illustrated.

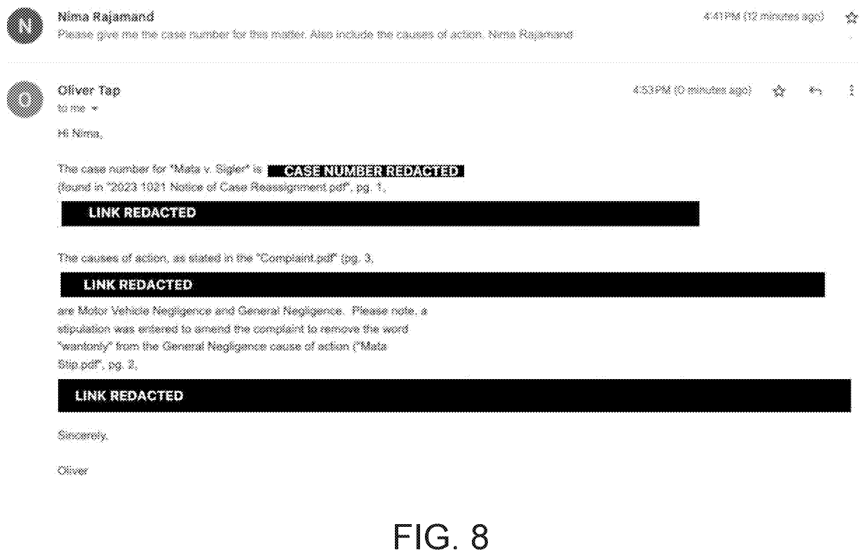

Referring to FIG. 8, the AI assistant's 102 email response providing the case number and causes of action, with links to relevant document sections, is illustrated.

FIGS. 7 to 8 illustrate a first scenario (Scenario 1) for an example of information retrieval.

In FIG. 7, a user sends an email to the assistant with the subject line “Mata v Sigler” and the body text “Please give me the case number for this matter. Also include the causes of action.” This triggers the following processing flow: (1) The Message Handler (FIG. 3A, Nodes 303-308) receives and analyzes the email, extracting the intent (“retrieve_information”), the case reference (“Mata v. Sigler”), and the specific data requested (“case number” and “causes of action”). (2) At Node 312 (FIG. 3B), the system determines it cannot answer without further information. (3) At Node 313, the system matches the request to an existing project for “Mata v. Sigler” based on the sender's project portfolio. (4) The Data Retriever (FIG. 5A/5B) identifies the relevant document categories (“Pleading”, “Court Order”), retrieves document summaries, filters for relevance, drills down to chunk summaries, and ultimately locates the specific pages containing the case number (in a “Notice of Case Reassignment” document, page 1) and the causes of action (in a “Complaint” document, page 3). (5) Additionally, the system locates a stipulation document noting an amendment to remove the word “wantonly” from the General Negligence cause of action. (6) The Response Composer (Node 318) generates the email shown in FIG. 8, which includes the case number, specific document and page references, download links, and the relevant note about the stipulation amendment.

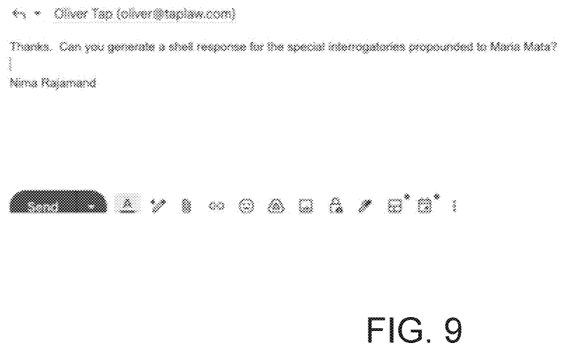

Referring to FIG. 9, a user requesting a shell response to interrogatories via email is illustrated.

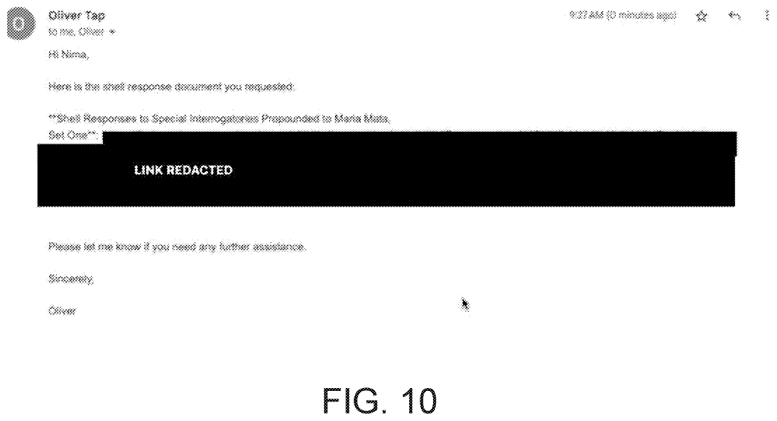

Referring to FIG. 10, the AI assistant's 102 email response is illustrated, providing the generated shell response document after retrieving the correct document from the correct project simply based on the information provided in the email of FIG. 9.

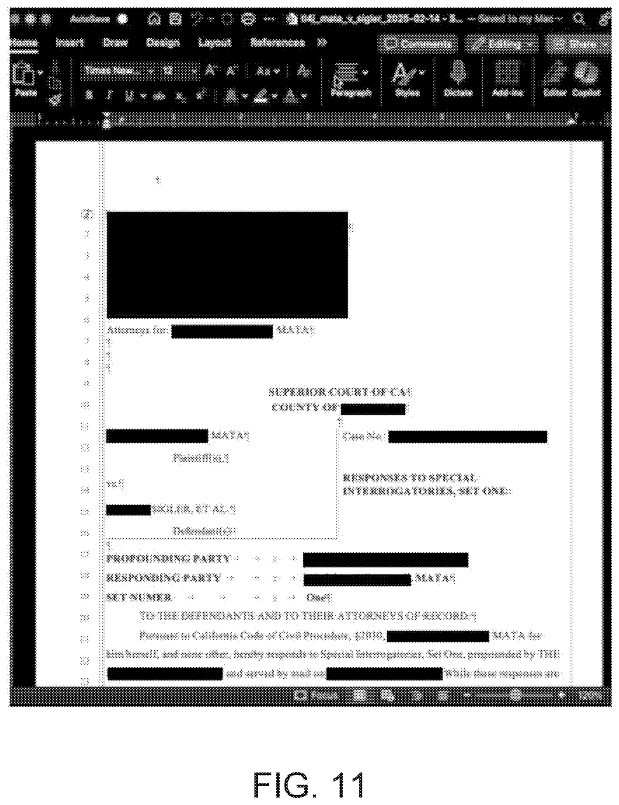

Referring to FIG. 11, a view of data provided by the AI assistant 102 in the form of a legal document is illustrated.

FIGS. 9 to 11 illustrate a second scenario (Scenario 2) of an example of document generation.

In FIG. 9, the same user replies to the assistant's previous email requesting “Can you generate a shell response for the special interrogatories propounded to Maria Mata?” This triggers: (1) Message analysis identifies the intent as “generate_document” with the specific task “shell response to special interrogatories” and the responding party “Maria Mata”. (2) The system matches this to the same “Mata v. Sigler” project. (3) The Data Retriever locates the original special interrogatories document within the project. (4) The Microservice Selection LLM (Node 316) determines that the GenerateShellDocument microservice should be invoked, and populates its parameters with: template_type=‘interrogatory_response’, case details, party names, court information, and the interrogatory content. (5) The microservice (Node 317) generates the shell document. (6) The response in FIG. 10 provides the generated document with a download link. FIG. 11 shows the actual generated legal document—a properly formatted “Responses to Special Interrogatories, Set One” with all case caption information, party names, and procedural language pre-populated from the project data.

While FIGS. 7 to 11 illustrate some example email flows, the present disclosure is not limited thereto, and other requests and responses may be applicable as described above.

Some additional examples for communicating over SMS may include, but is not limited to: a user sending an SMS, “Summarize latest email thread with John Doe,” and the AI assistant 102 would then retrieve the relevant email thread, generate a summary, and send the summary back via SMS; a user sending an SMS, “Schedule meeting with Jane Smith next week,” and the AI assistant 102 processes the data making the appropriate scheduling arrangements.

These examples would highlight some of the AI assistant's 102 ability to handle diverse requests, seamlessly switching between email and SMS as needed, and providing concise and informative responses. They serve to illustrate some of the functionality and utility of the proposed system.

Some embodiments may further include the addition of a voice interface, such that integration with speech-to-text and text-to-speech engines would enable users to interact with the AI assistant 102 using voice commands, either through a dedicated voice interface or by interacting with voice-enabled email or messaging clients. Further, in some embodiment, personalized models may be used. While the AI assistant's 102 core functionality described above relies on pre-trained AI models, the system may be extended to incorporate personalized models. These models could be trained on a user's specific data (email and SMS history, documents) to improve accuracy and relevance for that particular user.

In some embodiments, different database technologies may be used. While an example described above mentions NoSQL databases, the data retriever 228 and the secure database 208 could also be implemented using relational databases (e.g., PostgreSQL, MySQL) or graph databases (e.g., Neo4j), depending on the specific performance and scalability requirements.

In some embodiments, different OCR engines may be provides, such that many different OCR engines exist, and the ideal selection can be made modularly or for user preference.

As described above, the AI assistant may offer a robust, comprehensive, and end-to-end solution for automating email and SMS-based workflows. It may eliminate the need for specialized training or embedding generation, simplifying complex tasks and making advanced AI capabilities accessible through familiar communication channels. By leveraging one or more powerful LLM for analysis, summarization, and decision-making, and by integrating a structured retrieval layer and function-calling capabilities, the AI assistant may provide a significant advancement in intelligent communication and task management.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A system comprising:
a processor; and
memory containing instructions that, when executed by the processor, cause the processor to:
receive a message over email or short message service (SMS);
invoke one or more large language models (LLMs) to:
identify a unique identifier associated with a sender of the message;
analyze the message to identify a task;
retrieve data corresponding to the task from a data silo associated with the unique identifier;
invoke one or more microservices to perform the task based on the retrieved data; and
generate a response; and
transmit the response to the sender over email or SMS.

2. The system of claim 1, wherein to identify the unique identifier, the one or more LLMs are configured to:
parse metadata of the message;
identify an email address or a phone number from the metadata of the message; and
determine the unique identifier associated with the email address or the phone number.

3. The system of claim 1, wherein to analyze the message, the one or more LLMs are configured to parse headers and body text of the message to:
identify an intent of the sender of the message;
determine entities identified in the message;
identify command keywords;
determine attachment identifiers;
determine references to prior data or documents; and
generate an analyzed message with attachments.

4. The system of claim 3, wherein the instructions, when executed by the processor, further causes the processor to:
retrieve the analyzed message with attachments;
identify a document from the attachments;
split the document into pages;
perform optical character recognition (OCR) for each page of the document to generate a corresponding page object;
recombine page objects of the document;
split recombined page objects into chunks;
invoke one or more LLMs to generate a chunk level summary of each of the chunks;
recombine the chunk level summaries; and
invoke one or more LLMs to generate a full document summary based on the recombined chunk level summaries.

5. The system of claim 1, wherein to retrieve the data corresponding to the task, the one or more LLMs are further configured to:
identify an analyzed message associated with the unique identifier;
retrieve a document summary from the data silo associated with the analyzed message;
determine whether or not the document summary is relevant to the task;
in response to determining that the document summary is relevant, retrieve a chunk level summary associated with the document summary from the data silo;
determine whether or not the chunk level summary is relevant to the task;
in response to determining that the chunk level summary is relevant, retrieve a page object associated with the chunk level summary from the data silo;
determine whether or not the page object is relevant to the task; and
in response to determining that the page object is relevant, transmit the page object to the one or more microservices for further processing according to the task.

6. The system of claim 5, wherein the one or more microservices comprise at least one of a shell generating microservice, a bates stamping microservice, a meeting scheduling microservice, a legal research performing microservice, or a text translating microservice.

7. The system of claim 1, wherein to generate the response, the one or more LLMs are configured to:
identify an analyzed message with attachments;
receive one or more processed page objects from the one or more microservices; and
generate the response including at least one of references to specific pages for documents, chunk identifiers, message timestamps, or newly generated links, based on the analyzed message and the one or more processed page objects.

8. Non-transitory computer readable media containing instructions that, when executed by a process, cause the processor to:
receive a message over email or short message service (SMS);
invoke one or more large language models (LLMs) to:
identify a unique identifier associated with a sender of the message;
analyze the message to identify a task;
retrieve data corresponding to the task from a data silo associated with the unique identifier;
invoke one or more microservices to perform the task based on the retrieved data; and
generate a response; and
transmit the response to the sender over email or SMS.

9. The non-transitory computer readable media of claim 8, wherein to identify the unique identifier, the instructions further cause the processor to invoke the one or more LLMs to:
parse metadata of the message;
identify an email address or a phone number from the metadata of the message; and
determine the unique identifier associated with the email address or the phone number.

10. The non-transitory computer readable media of claim 8, wherein to analyze the message, the instructions further cause the processor to invoke the one or more LLMs to parse headers and body text of the message to:
identify an intent of the sender of the message;
determine entities identified in the message;
identify command keywords;
determine attachment identifiers;
determine references to prior data or documents; and
generate an analyzed message with attachments.

11. The non-transitory computer readable media of claim 10, wherein the instructions further causes the processor to:
retrieve the analyzed message with attachments;
identify a document from the attachments;
split the document into pages;
perform optical character recognition (OCR) for each page of the document to generate a corresponding page object;
recombine page objects of the document;
split recombined page objects into chunks;
invoke one or more LLMs to generate a chunk level summary of each of the chunks;
recombine the chunk level summaries; and
invoke one or more LLMs to generate a full document summary based on the recombined chunk level summaries.

12. The non-transitory computer readable media of claim 8, wherein to retrieve the data corresponding to the task, the instruction further cause the processor to invoke the one or more LLMs to:
identify an analyzed message associated with the unique identifier;
retrieve a document summary from the data silo associated with the analyzed message;
determine whether or not the document summary is relevant to the task;
in response to determining that the document summary is relevant, retrieve a chunk level summary associated with the document summary from the data silo;
determine whether or not the chunk level summary is relevant to the task;
in response to determining that the chunk level summary is relevant, retrieve a page object associated with the chunk level summary from the data silo;
determine whether or not the page object is relevant to the task; and
in response to determining that the page object is relevant, transmit the page object to the one or more microservices for further processing according to the task.

13. The non-transitory computer readable media of claim 12, wherein the one or more microservices comprise at least one of a shell generating microservice, a bates stamping microservice, a meeting scheduling microservice, a legal research performing microservice, or a text translating microservice.

14. The non-transitory computer readable media of claim 8, wherein to generate the response, the instructions further cause the processor to invoke the one or more LLMs to:
identify an analyzed message with attachments;
receive one or more processed page objects from the one or more microservices; and
generate the response including at least one of references to specific pages for documents, chunk identifiers, message timestamps, or newly generated links, based on the analyzed message and the one or more processed page objects.

15. A method comprising:
receiving, by a processor, a message over email or short message service (SMS);
invoking, by the processor, one or more large language models (LLMs) to:
identify a unique identifier associated with a sender of the message;
analyze the message to identify a task;
retrieve data corresponding to the task from a data silo associated with the unique identifier;
invoke one or more microservices to perform the task based on the retrieved data; and
generate a response; and
transmitting, by the processor the response to the sender over email or SMS.

16. The method of claim 15, wherein the identifying of the unique identifier comprises:
parsing, by the one or more LLMs, metadata of the message;
identifying, by the one or more LLMs, an email address or a phone number from the metadata of the message; and
determining, by the one or more LLMs, the unique identifier associated with the email address or the phone number.

17. The method of claim 15, wherein the analyzing of the message comprises parsing, by the one or more LLMs, headers and body text of the message to:
identify an intent of the sender of the message;
determine entities identified in the message;
identify command keywords;
determine attachment identifiers;
determine references to prior data or documents; and
generate an analyzed message with attachments.

18. The method of claim 17, further comprising:
retrieving, by the processor, the analyzed message with attachments;
identifying, by the processor, a document from the attachments;
splitting, by the processor, the document into pages;
performing, by the processor, optical character recognition (OCR) for each page of the document to generate a corresponding page object;
recombining, by the processor, page objects of the document;
splitting, by the processor, recombined page objects into chunks;
invoking, by the processor, one or more LLMs to generate a chunk level summary of each of the chunks;
recombining, by the processor, the chunk level summaries; and
invoking, by the processor, one or more LLMs to generate a full document summary based on the recombined chunk level summaries.

19. The method of claim 15, wherein the retrieving of the data corresponding to the task comprises:
identifying, by the one or more LLMs, an analyzed message associated with the unique identifier;
retrieving, by the one or more LLMs, a document summary from the data silo associated with the analyzed message;
determining, by the one or more LLMs, whether or not the document summary is relevant to the task;
in response to determining that the document summary is relevant, retrieving, by the one or more LLMs, a chunk level summary associated with the document summary from the data silo;
determining, by the one or more LLMs, whether or not the chunk level summary is relevant to the task;
in response to determining that the chunk level summary is relevant, retrieving, by the one or more LLMs, a page object associated with the chunk level summary from the data silo;
determining, by the one or more LLMs, whether or not the page object is relevant to the task; and
in response to determining that the page object is relevant, transmitting, by the one or more LLMs, the page object to the one or more microservices for further processing according to the task,
wherein the one or more microservices comprise at least one of a shell generating microservice, a bates stamping microservice, a meeting scheduling microservice, a legal research performing microservice, or a text translating microservice.

20. The method of claim 15, wherein the generating of the response comprises:
identifying, by the one or more LLMs, an analyzed message with attachments;
receiving, by the one or more LLMs, one or more processed page objects from the one or more microservices; and
generating, by the one or more LLMs, the response including at least one of references to specific pages for documents, chunk identifiers, message timestamps, or newly generated links, based on the analyzed message and the one or more processed page objects.
